(19) United States
(12) Patent Application Publication
(10) Pub. No.: US 2014/0173266 A1
(43) Pub. Date: Jun. 19, 2014

(54) INFORMATION PROCESSING APPARATUS AND INFORMATION PROCESSING METHOD

(71) Applicant: Kabushiki Kaisha Toshiba, Tokyo (JP)

(72) Inventors: Toshitaka Sanada, Ome-shi (JP); Shuji Hori, Saitama (JP)

(21) Appl. No.: 13/938,668

(22) Filed: Jul. 10, 2013

(30) Foreign Application Priority Data
Dec. 18, 2012 (JP) 2012-276144

(51) Int. Cl. G06F 21/57

(52) U.S. Cl. CPC G06F 21/572
USPC 713/2

(57) ABSTRACT

One embodiment provides an information processing apparatus including: a setting module configured to allow an administrator to set usable-date/time information during which a user is allowed to use the information processing apparatus; a storage module configured to store the usable-date/time information which is set by the administrator; and a control module configured to control use of the information processing apparatus by the user based on the stored usable-date/time information.

### CROSS-REFERENCE TO RELATED APPLICATION(S)

This application claims priority (priorities) from Japanese Patent Application No. 2012-276144 filed on Dec. 18, 2012, the entire contents of which are incorporated herein by reference.

### FIELD

Embodiments described herein relate generally to an information processing apparatus and an information processing method.

### BACKGROUND

In a company etc., an administrator password may be set, and employees without the administrator right may be prohibited from changing setting of PC, or accessing external device. However, it is may not be possible to prohibit the employee from using the PC depending on whether or not it is during a time period for which use of the PC is allowed by the administrator.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 illustrates the outer appearance of an information processing apparatus according to an embodiment.

FIG. 2 illustrates the internal configuration of a computer 101 according to the embodiment.

FIG. 3 illustrates an example of the content of a non-volatile memory used in the embodiment.

FIG. 4 illustrates a flowchart (1) of an example of the embodiment.

FIG. 5 illustrates a flowchart (2) of an example of the embodiment.

FIG. 6 illustrates a flowchart (3) of an example of the embodiment.

FIG. 7 illustrates a flowchart of the example of the embodiment (current time changing process).

FIG. 8 illustrates a flowchart of the example of the embodiment (PC-usable-date/time limiting-function setting process).

FIG. 9 illustrates a flowchart of the example used in the embodiment (process for checking temporary-release password).

FIG. 10 illustrates a flowchart of the example used in the embodiment (PC power supply OFF process).

### DETAILED DESCRIPTION

One embodiment provides an information processing apparatus including: a setting module configured to allow an administrator to set usable-date/time information during which a user is allowed to use the information processing apparatus; a storage module configured to store the usable-date/time information which is set by the administrator; and a control module configured to control use of the information processing apparatus by the user based on the stored usable-date/time information.

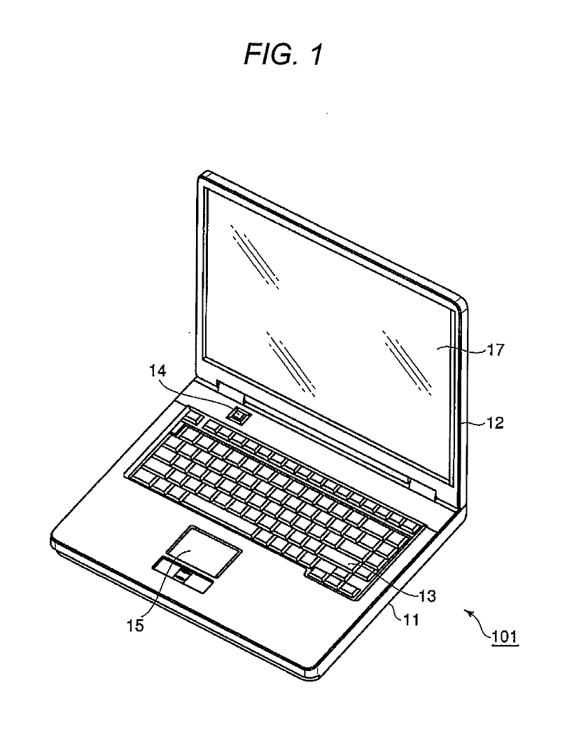

An embodiment will now be described with reference to FIGS. 1 to 9.

The configuration of an information processing apparatus according to an embodiment is illustrated in FIG. 1. This information processing apparatus is realized as, e.g., a battery-drivable notebook type portable personal computer. This computer 101 is configured to allow connection of various I/O devices (option I/O devices) such as USB (Universal Serial Bus) device, and/or PCI Express card device corresponding to PCI Express (Peripheral Component Interconnect Express) standard, etc.

This computer 101 comprises a body 11 and a display unit 12. On the upper surface of the body 11, a keyboard 13, a power button switch 14 to turn ON/OFF the computer 101, a touch pad 15, etc. and the like are provided On the back face of the body 11, for example, a connecting port for connecting the various kinds of option I/O devices may be disposed. The display unit 12 incorporates a display device such as a LCD (Liquid Crystal Display) 17, and the display screen of the LCD 17 is positioned substantially at the center of the display unit 12. The display unit 12 is supported by the body 11 so as to be rotatable between an opening position where the upper face of the body 11 is exposed to and a closed position where the upper face of the body 11 is closed.

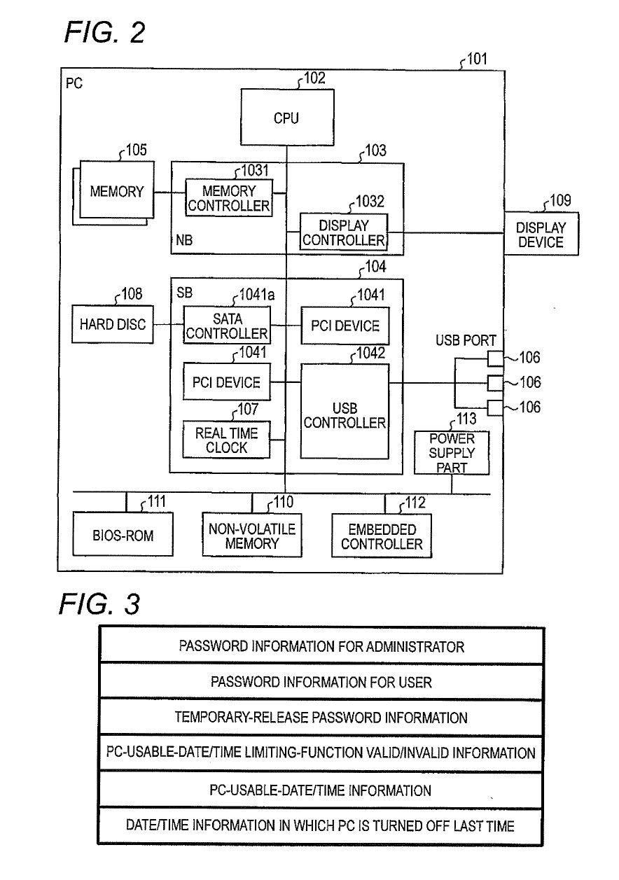

FIG. 2 illustrates the internal configuration of the computer 101 according to the embodiment. As shown in FIG. 2, the computer 101 includes a CPU 102, a north bridge 103, a south bridge 104, a memory 105, a USB port 106, a hard disc 108, a display device 109, a non-volatile memory 110, a BIOS-ROM 111, an embedded controller 112, and a power supply part 113. Although this embodiment exemplifies a case where the computer 101 supplies power to a USB device, the computer 101 may supply power to an IEEE1394 device, etc.

The CPU 102 is a main computing unit or a processor for controlling the operation of the computer (PC main body) 101. The CPU 102 causes the memory 105 to load a system BIOS (Basic Input Output System) stored in the BIOS-ROM 110 to control various kinds of hardware. Also, the CPU 102 causes the memory 105 to load an OS (Operating System) stored on the hard disc 108 to execute not only OR but also various programs other than the system BIOS and the OS.

The north bridge 103 is a chip, and performs control related to memory and/or display. The north bridge 103 connects the CPU 102 and the south bridge 104. Thus, the north bridge 103 provides an access to the memory 105 through a memory controller 1031 by the CPU 102, and controls the display device 109 to perform various displays through a display controller 1032.

The south bridge 104 is a chip, performs control of a PCI device and an LPC (Low Pin Count) bus device, etc., and connects the CPU 102 and various kids of hardware such as BIOS-ROM 111, the non-volatile memory 110, e.g., an embedded controller 112. The embedded controller 112 may constitute a part of the so-called EC/KBC connected to LPC bus. The BIOS-ROM 111 stores the BIOS program corresponding to processing of this embodiment, etc. The BIOS controls the computer 101. The embedded controller 112 is a KBC (KeyBoard Controller), and performs various functions, such as controlling of key input, etc. from the keyboard.

As shown in FIG. 2, the south bridge 104 includes a PCI (Peripheral Interconnect) device 1041, a USB (Universal Serial Bus) controller 1042, and a real time clock (RTC: Real Time Clock) 107.

A SATA (Serial Advanced Technology Attachment) controller 1041a which is one of the PCI devices 1041 controls input/output of various data to and from the hard disc 108.

The USB controller 1042 detects, upon insertion of the USB devise into the USB port 106, a signal indicating that effect. Also, the USB controller 1042 controls transmission/reception of various commands and/or data with respect to the inserted USB device.

The real time clock 107 counts a current time of the computer 101. The real time clock 107 has a timer function, and can count a current time even when the power supply of the computer is in OFF state. When the counted current time reaches a time which is set from a power supply setting part (not shown) of the BIOS-ROM 111, the real time clock 107 sends an instruction to a starting part (not shown) of the BIOS-ROM 111 such that various hardwares within the computer 101 are started.

The memory 105 is a main memory for deploying the system BIOS (BIOS) stored in BIOS-ROM 111, and OS and/or application programs stored on the hard disc 108 to acquire them.

The hard disc 108 stores the OS and/or various kinds of application programs, etc.

The display device 109 is a display device such as LCD (Liquid Crystal Display) 17, etc., and displays screens of various kind of application programs and/or screens of utility in accordance with control of the north bridge 103.

The non-volatile memory 110 is a memory medium such as EEPROM (Electrically Erasable Programmable ROM) and/or flash memory, etc., and stores various kinds of information. For example, the non-volatile memory 110 stores data for performing USB supply power to the USP device inserted into the USP port 106, including switching of power supply modes.

The power supply modes specify the conditions of applications and/or hardwares in the computer 101 various charging operations, respectively.

There will now be roughly described a method in which the BIOS performs administrative operation of setting a PC-usable-date/time, thereby prohibiting the non-administrator user from using the PC for a time period set by the administrator.

FIG. 3 illustrates an example of the information stored in the non-volatile memory 110. For example, the PC-usable-date/time limiting-function valid/invalid information corresponds to a “time-period checking flag”, and there is set binary flag as to whether the PC-usable-date/time limiting-function is valid or invalid. Moreover, the PC-usable-date/time information corresponds to “date/time information”, and describes date/time range during which a limitation is applied depending on the PC-usable-date/time limiting-function. Moreover, the date/time information in which the PC is turned OFF last time corresponds to “PC-last-turned-OFF information” which is obtained by storing date/time information counted by the RTC into the non-volatile memory 110.

Only the BIOS is allowed to perform read/write of these various information. Such operation can be realized by security control chip (not shown) connected to the same bus as, e.g., the EC/KBC.

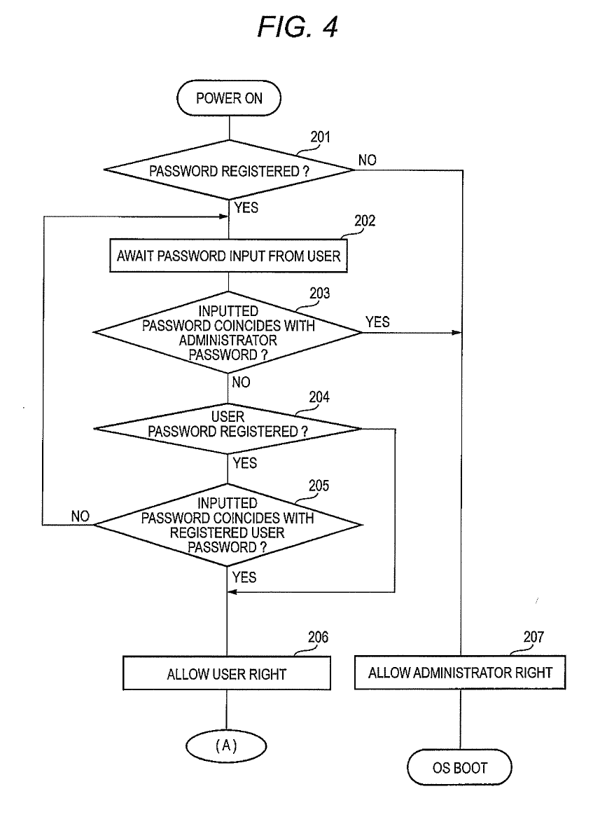

FIGS. 4 to 6 illustrate BIOS control flows in the embodiment in the case where the PC is turned ON. In this embodiment, these processings are performed mainly by the BIOS unless otherwise specifically described. In this embodiment, while the EC/KBC controls keyboard (not shown), the CPU 102 executes processing corresponding to inputs from the keyboard.

FIG. 4 is a flowchart up to when the right is given.

First, when the PC is turned ON, the BIOS determines whether or not the password is registered (step S201). In the case where the password is not registered (No of the step S201), the BIOS boots the OS while giving “administrator right” (step S207). In the case where the password is registered (Yes of the step S201), the BIOS outputs, to the display device 109, an information for requesting the user to input password, and awaits the user's input (step S202). The administrator right means the right to use the PC as the administrator (super user, supervisor).

Upon input of password from the keyboard, in the case where administrator password is registered in the non-volatile memory 110, the BIOS confirms whether or not the inputted password coincides with the registered administrator password (step S203). In the case where the inputted password coincides with the administrator password (Yes of step S203), the OS is booted so as to be given with the “administrator right”.

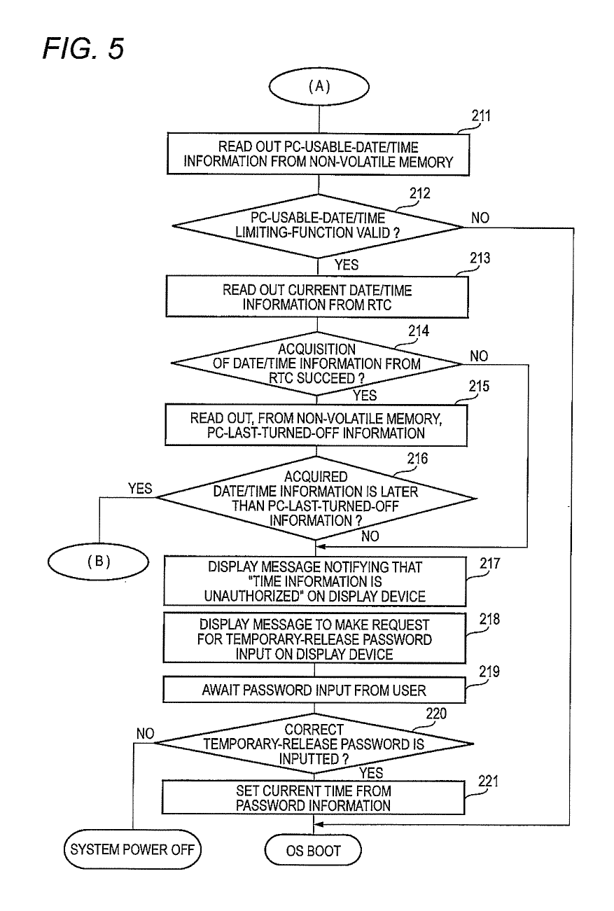

In the case where the BIOS does not coincide with the administrator password, or the administrator password is not registered (No of the step S203), the BIOS determines as to whether or not the user password is registered in the non-volatile memory 110 (step S204). In the case where no user password is registered (No of the step S204), the “user right” is given (step S206). The user right means the right to use the PC as the general user, not as the administrator. Process steps subsequent to the step S206 will now be described with reference to the following FIG. 5.

In the case where the user password is registered (Yes of the step S204), the BIOS confirms whether or not the inputted password coincides with the registered user password.

In the case where the inputted password coincides with the user password (Yes of step S205), the “user right” is given (step S206). On the other hand, in the case where the inputted password does not coincides with the user password (No of the step S205), process returns to the step S202 to await password input from user.

FIG. 5 is a flowchart indicating a process to determine as to whether or not time information of the PC is unauthorized after giving the user right. Subsequently to the step S206 of FIG. 4, the BIOS acquires, from the non-volatile memory 110, the PC-usable-date/time limiting-function valid/invalid information. The BIOS makes checking as to whether or not the PC-usable-date/time limiting-function is valid (step S212). In the case where it is invalid (No of step S212), the OS is booted. In the case where the PC-usable-date/time limiting-function is valid (Yes of the step S212), the BIOS reads out a current date/time information from the RTC (step S213).

Subsequently to step S213, the BIOS makes checking as to whether or not acquisition of the date/time information from the RTC succeeds (step S214). In the case where acquisition of the date/time information is failed (No of the step S214), the BIOS determines that the time information is unauthorized (reference is incomplete) to proceed to step S217. For example, in the case where the RTC is driven on a battery different from the computer, the RTC may miscount date/time due to the battery error.

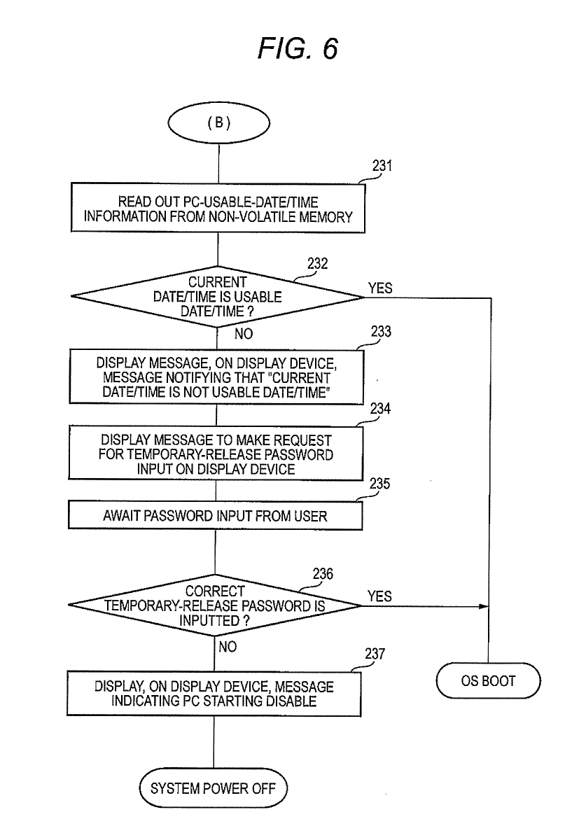

In the case where acquisition of the date/time information succeeds (Yes of the step S214), the BIOS reads out “PC-last-turned-OFF information” stored in the non-volatile memory 110 (step S215) to make checking as to whether or not the current date/time information acquired from the RTC is earlier (step S216). In the case where the current date/time information is earlier than the “PC-last-turned-OFF information”, the BIOS determines as to whether or not time information is unauthorized. In the case where it is not so (Yes of the step S216), process proceeds to the next step S231 of FIG. 6.

In the case where it is determined that the time information is unauthorized (No of step S216), the BIOS causes the display device to display message notifying that “time information is unauthorized” (step S217) and a message to make a request for input of temporary-release password (step S218) to await input from the user (step S219). Thus, in the case where time information of the PC is unauthorized, it is possible to prohibit use of the computer unless the temporary-release password is inputted.

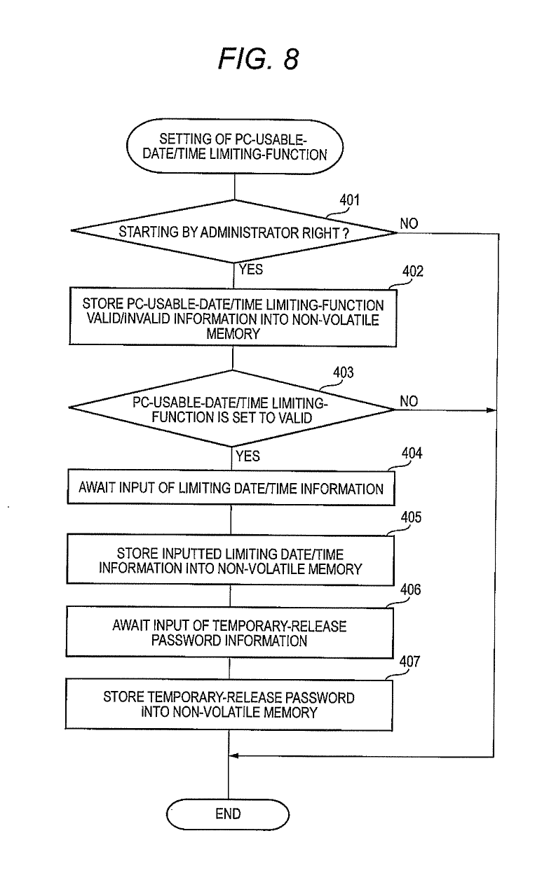

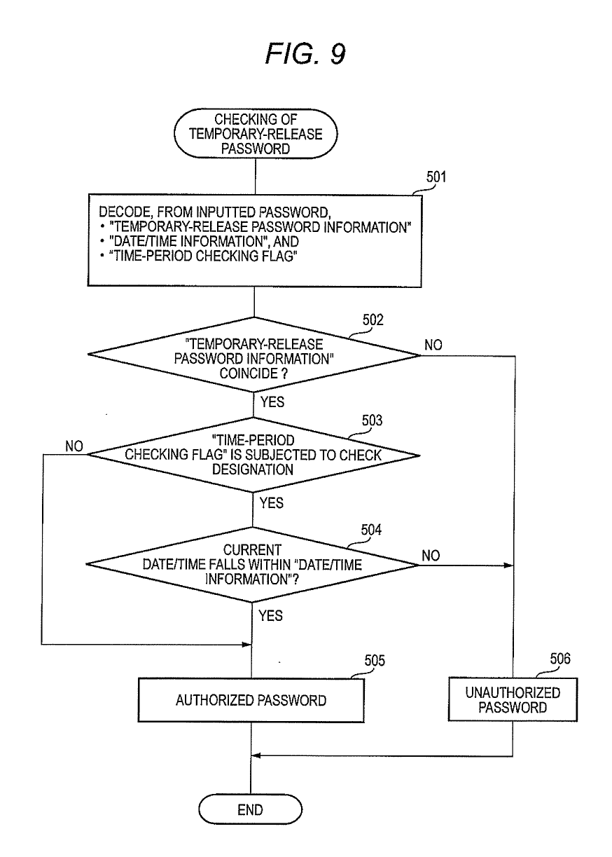

When the time information is unauthorized, the user will ask an administrator to let him/her know the temporary-release password. In the temporary-release password, “temporary-release password information”, “date/time information” and “time-period checking flag” are included in encrypted state. “The temporary-release password information” is a password for allowing user to temporarily use the PC, or for resetting time information of RTC (Password used in step S4 of FIG. 8 and step S502 of FIG. 9), and “date/time information”, “time-period checking flag ” are the previously described ones.

In the case where correct temporary-release password is inputted (Yes of step S220), the BIOS sets the “date/time information” included in the temporary-release password as a current date/time of the RTC (step S221, (elimination of the incompleteness)), and boots the OS. Namely, in the case where the time information of the PC is unauthorized, the time information of PC can be corrected by the administrator.

In the case where correct temporary-release password is not inputted (No of the step S220), the BIOS turns OFF the PC.

FIG. 6 is a flowchart indicating a process to determine whether or not it is within the PC-usable-date/time in the case where the time information of the PC is determined to be of not unauthorized.

In the case where the BIOS determines that current date/time information acquired from the RTC of FIG. 5 is not unauthorized (Yes of the step S216), the BIOS reads out PC-usable-date/time information from the non-volatile memory 110 (step S231).

In the case where the BIOS makes checking as to whether or not the current date/time is usable date/time (step S232, (reference of date/time)), and determines that the current date/time is usable date/time (Yes of the step S232), the OS is booted. On the other hand, the following steps are executed to prohibit the non-administrator user from using the computer except for the usable date/time.

In the case where it is determined that current date/time is not usable date/time (No of step S232), the BIOS causes the display device to display a message notifying that “it is not usable date/time” (step S233) and a message to request for input of temporary-release password from the user (step S234) to await input from user (step S235). User will ask the administrator to let him/her know temporary-release password. As previously described, the temporary-release password includes “temporary-release password information”, “date/time information” and “time-period checking flag” in encrypted state.

In the case where correct temporary-release password is inputted from user (Yes of the step S236), the BIOS is booted. As a result, a non-administrator user can use temporarily the computer even for a time period which is set (permitted) by the administrator.

In the case where the password does not coincide (No of the step S236), the BIOS causes the display device to display a message indicating that the PC cannot be started (step S237), and turns OFF the power supply of the PC.

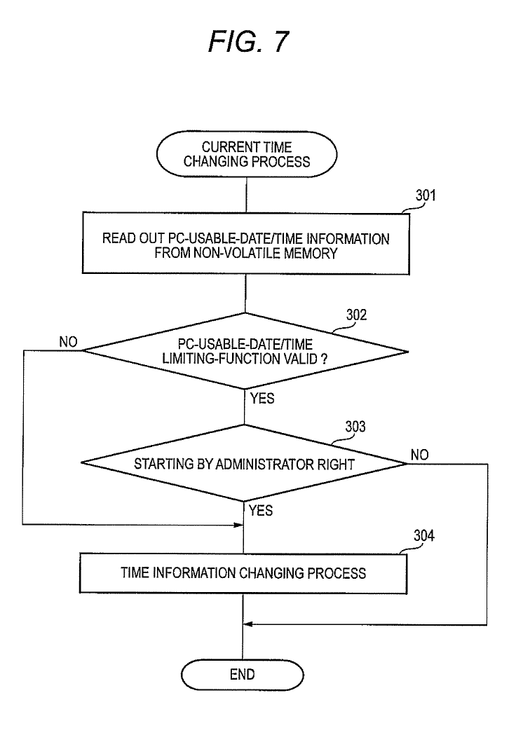

FIG. 7 is a control flowchart of processing of changing the current time in the RTC. First, the BIOS acquires “PC-usable-date/time limiting-function valid/invalid information” from the non-volatile memory 110″ (step S301).

The BIOS makes checking as to whether or not the PC-usable-date/time limiting-function is valid (step S302). In the case where it is not valid (No of step S302), the current time changing process is allowed to proceed (No of step S304).

In the case where it is valid (Yes of the step S302), the BIOS makes checking as to whether or not the PC starting operation is executed by the administrator right (step S303). In the case where the PC starting operation is not performed by the administrator right (No of the step S303), process ends.

In the case where the PC starting operation is executed by the administrator right (Yes of the step S303), the BIOS allows the RTC to perform the current time changing process step (step S304).

FIG. 8 is a control flowchart of the PC-usable-date/time limiting-function setting. This function may be included in BIOS SETUP. First, the BIOS makes checking as to whether or not the PC is started by the administrator right (step S401). In the case where it is determined that the PC is not started by the administrator right (No of the step S401), process ends.

In the case where it is determined that the PC is started by the administrator right (Yes of the step S401), the BIOS causes the non-volatile memory 110 to store PC-usable-date/time limiting-function valid/invalid information (step S402).

Next, in the case where the PC-usable-date/time limiting-function is invalid (No of step S403), the BIOS ends without performing no operation at times subsequent thereto. In the case where the PC-usable-date/time limiting-function is valid (Yes of the step S403), the BIOS makes a request for input of limiting date/time information from user (step S404).

The BIOS causes the non-volatile memory 110 to store the inputted limiting date/time information (step S405). The BIOS makes a request for input of temporary-release password, etc. from user (step S406). And, the BIOS causes the non-volatile memory 110 to store the inputted password (step S407).

FIG. 9 is a flowchart of process of checking temporary-release password from user (step S406). First, the BIOS decodes, from the inputted password, “temporary-release password information”, “date/time information” and “time-period checking flag” which have been encrypted (step S501).

Next, the BIOS makes checking as to whether or not the decoded “temporary-release password information” coincides with the “temporary-release password” set by the administrator in step S407 (step S502). In the case where the former does not coincide with the latter (No of the step S502), the BIOS determines such a password as an unauthorized password (step S506), and ends the process.

In the case where it is determined that the password is authorized password (Yes of step S502), the BIOS makes checking of the decoded “time-period checking flag” (step S503), and when it is not checked (No of step S503), it is determined as authorized password (step S505).

If the decoded “time-period checking flag” is set (Yes of the step S503), the BIOS compares the decoded “date/time information” and current date/time information read out from the RTC (see the step S213), whereby when this read-out current date/time information falls within the decoded “date/time information” (Yes of step S504), the BIOS determines it as authorized password (step S505). On the other hand, if not (No of the step S504), the BIOS determines it as unauthorized password, and ends processing. For example, the administrator may be allowed to specify the date/time information as a width such as “2012 Oct. 29 10:00”-“2012 Oct. 29 11:00”, so that the password is determined as authorized password as long as the read-out current date/time information falls within it.

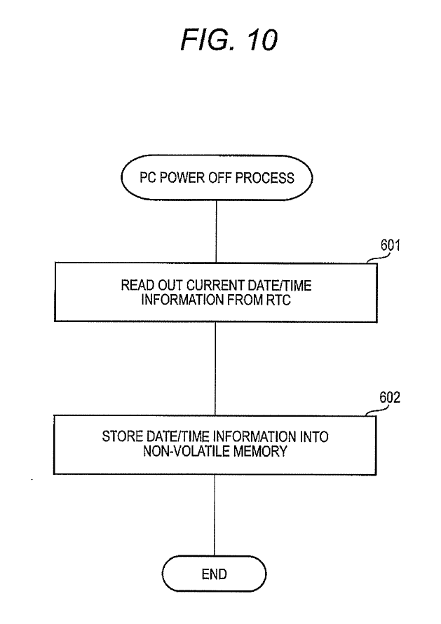

FIG. 10 is a flowchart when the PC is turned OFF. Initially, the BIOS reads out current date/time information from the RTC (step S601). Then, the BIOS causes the non-volatile memory 110 to store read-out date/time information as “PC-last-turned-OFF information” (step S602)

In this embodiment, the BIOS administrates the PC-usable-date/time, thereby enabling limitation of use time of the computer with respect to a non-administrator user not having the administrator right. Because management is performed by the BIOS, during a time period set by the administrator, even starting of OS can be prohibited. Meanwhile, the administrator can selectively permit the non-administrator user to use the computer during such time period.

The present invention is not limited to the above embodiment, but can be variously implemented within the scope thereof.

A plurality of components disclosed in the above-described embodiments may be combined as occasion demands to thereby have ability to form various inventions. For example, several components may be deleted from all components illustrated in the embodiments. In addition, embodiments may be combined as occasion demands.

1. An information processing apparatus comprising:
a setting module configured to allow an administrator to set usable-date/time information during which a user is allowed to use the information processing apparatus;
a storage module configured to store the usable-date/time information which is set by the administrator; and
a control module configured to control use of the information processing apparatus by the user based on the stored usable-date/time information.

2. The information processing apparatus of claim 1,
wherein the setting module and the control module are executed by a BIOS.

3. The information processing apparatus according to claim 1,
wherein the control module allows the user to temporary use the information processing apparatus in date/time not fall within the usable-date/time information upon authorization by the administrator.

4. The information processing apparatus of claim 1,
wherein the control module prohibits the user to use the information processing apparatus when a reference is incomplete.

5. The information processing apparatus of claim 1,
wherein the control module allows the user to make setting to eliminate an incompleteness of reference upon authorization by the administrator.

6. An information processing method comprising:
allowing an administrator to set usable-date/time information during which a user is allowed to use the information processing apparatus;
storing the usable-date/time information which is set by the administrator; and
controlling use of the information processing apparatus by the user based on the stored usable-date/time information.

7. The information processing method of claim 6,
wherein the BIOS stored in a storage module of the information processing apparatus executes the setting step, the storage step and the control step.
